(19) United States
(12) Patent Application Publication
(10) Pub. No.: US 2004/0124262 A1
(43) Pub. Date: Jul. 1, 2004

(54) Apparatus for installation of loose fill insulation

(76) Inventors: David James Bowman, Charlotte, NC (US); Mary Elizabeth Cooper, Fort Mill, SC (US)

Correspondence Address: MACCORD MASON PLLC, 300 N. GREENE STREET, SUITE 1600, P. O. BOX 2974, GREENSBORO, NC, 27402, US

(21) Appl. No.: 10/334,685

(22) Filed: Dec. 31, 2002

(51) Int. Cl. B05B 9/03

(52) U.S. Cl. 239/302

(57) ABSTRACT

An apparatus for installation of a material having discrete elements, such as loose fill insulation. The apparatus includes a supply of the material and an applicator assembly for activating a substantially water-free adhesive for providing structure to the material during installation. In the preferred embodiment, the applicator assembly includes: a nozzle having an inlet for receiving the material and an outlet for applying the material to a surface; and an adhesive applicator adjacent to the nozzle for activating the substantially water-free adhesive to provide structure to the material having discrete elements during installation. Also, in the preferred embodiment, the apparatus includes a transporter system downstream of the supply of material for delivery of the material to the applicator assembly.

### BACKGROUND OF THE INVENTION

(1) Field of the Invention

The present invention relates generally to an apparatus for insulating walls or the like and, more particularly, to an apparatus for installing cellulosic fiber insulation into open stud cavities prior to the installation of the dry wall.

(2) Description of the Prior Art

Insulation is used in residential and commercial dwellings both to conserve energy and to reduce noise. The two most common types of insulation are blown and bat. Blown insulation may be made from several lightweight natural or man-made materials. Bat insulation is most commonly made from fiberglass. Blown loose fill insulation is most often used for attic floors since the insulation is less expensive, more quickly installed and still allows access to wiring, etc.

Fiberglass batting is still preferred for non-horizontal and floor insulation since the batting holds the fiberglass in place. The fiberglass batting is applied in the cavity formed by vertical wall studs, an outer wall, a bottom sill and a top plate. Once the bat is fixed in position, a vapor barrier may be mounted over the insulated wall. Dry wall or other inner wall material is then mounted to the studs to complete the inner wall.

While loose fill insulation is more difficult to install in a non-horizontal wall, it may still be blown or spread within the stud cavity. Typically, the blown insulation is an aggregate of insulation particles mixed with wet adhesive or water to form a spray. However, since the insulation is loose and flowable, it is necessary to retain the insulation in position prior to inserting the insulation in the wall cavity and/or prior to installation of the supporting skeletal wall.

One method was to utilize a perforated screen that was attached along the lower portion of the wall and moved upward as each section was completed. The perforated screen allowed the air being used to blow the insulation in place to escape but retained the loose fill insulation in place to allow the insulation to fill up behind the screen, dry and the water-based adhesive to set. This method has a number of drawbacks. First, it takes more time to put up the screening and more skilled labor than stapling up a bat of fiberglass. Also, there may be a substantial time delay in waiting for each section of insulation to dry and set before being able to move the screen to install the next section.

Another method was to utilize a plastic membrane to blow the loose insulation behind the membrane in the wall cavity. The insulation would then be tapped and packed in an effort to prevent future settling. Once the insulation was installed, the shield membrane was removed and dry wall or other wall materials could be applied to form the inner wall. This method had disadvantages, as well, because it required additional time delays and manpower to maintain the shield plate in position during installation of the insulation.

Still another method utilizes a netting material affixed to the wall studs to form an inner wall during the installation of the insulation. The netting is attached from floor to ceiling and forms a retaining barrier for the loose insulation to be blown in behind the netting. A hole was cut into the netting in order to receive the nozzle for delivery of insulation, which was then blended with an adhesive and water. Like the screen system, the netting permitted the air displaced by the positioned insulation to escape during the installation process. This method still has several disadvantages. For example, like the screen and membrane systems, the time involved with installing the retaining net is labor intensive and may not be easily done by just one person working alone.

As can be appreciated, blowing loose insulation material mixed with water and adhesive tends to be very messy and labor intensive in terms of cleanup. For example, the blow in methods very often cause insulation material to stick to the outer surface of the wall studs causing additional labor time to clean the stud face, in addition to a separate supply of water on the job site for the application process. In addition to the problems that water-based adhesives create for loose fill insulation, these systems can have inconsistent R values for the installation of the wall because of increased installed density of the insulation.

Thus, there remains a need for a new and improved apparatus for installation of a material having discrete elements, such as blown cellulosic or fiberglass insulation, which does not require netting to hold the material in place during installation while, at the same time, includes a substantially water-free adhesive for providing structure to the material during installation.

### SUMMARY OF THE INVENTION

The present invention is directed to an apparatus for installation of a material having discrete elements, such as loose fill insulation. The apparatus includes a supply of the material and an applicator assembly for activating a substantially water-free adhesive for providing structure to the material during installation. In the preferred embodiment, the applicator assembly includes: a nozzle having an inlet for receiving the material and an outlet for applying the material to a surface; and an adhesive applicator adjacent to the nozzle for activating the substantially water-free adhesive to provide structure to the material having discrete elements during installation. Also, in the preferred embodiment, the apparatus includes a transporter system downstream of the supply of material for delivery of the material to the applicator assembly.

In the preferred embodiment, the width of the outlet of the nozzle is greater than its height for accommodating most conventional cavity shapes. The adhesive applicator includes a supply of adhesive material and a spray head for supplying adhesive to the material having discrete elements. The supply of adhesive includes a hot melt adhesive and a heater assembly. In the preferred embodiment, the hot melt adhesive is a thermoplastic adhesive. The heater assembly further includes a temperature control device for controlling the temperature of the heater.

In the preferred embodiment, the spray head for supplying adhesive to the material having discrete elements provides a plurality of streams. Also, the spray head may further include a distributor downstream of the spray head. The distributor downstream of the spray head provides a plurality of air streams for improving mixing.

The applicator assembly may further include an air/solids separator upstream of the nozzle. The air/solids separator upstream of the nozzle is a partial separator. In the preferred embodiment, the partial separator removes greater than about 50% of the air from the air/solids mixture.

In the preferred embodiment, the transporter system includes a conduit with an inlet and outlet and an air supply to move the material having discrete elements through the conduit. The transporter system may further include a debailer for debailing bundles of the material having discrete elements.

The supply of material having discrete elements is selected from the group consisting of fibrous material, granular material, pellet material and agglomerated material. The supply of material having discrete elements may be inorganic or organic. The inorganic materials are preferably selected from the group consisting of fiberglass, rock wool, pearlite, mineral wool, and asbestos. The supply of material may include organic materials such as cellulose, polystyrene, and polyurethane. In the preferred embodiment, the organic material is a natural material, such as cellulose. Also, the material preferably is a non-conductive material. For example, the material may be thermally, acoustically, or electrically non-conductive.

Accordingly, one aspect of the present invention is to provide an apparatus for installation of a material having discrete elements, the apparatus comprising: a supply of material having discrete elements; and an applicator assembly for activating a substantially water-free adhesive for providing structure to the material having discrete elements during installation.

Another aspect of the present invention is to provide an applicator assembly for an apparatus for installation of a supply of material having discrete elements, the apparatus comprising: a nozzle having an inlet for receiving the material and an outlet for applying the material to a surface; and an adhesive applicator adjacent to the nozzle for activating a substantially water-free adhesive to provide structure to the material having discrete elements during installation.

Still another aspect of the present invention is to provide an apparatus for installation of a material having discrete elements, the apparatus comprising: a supply of material having discrete elements; an applicator assembly for activating a substantially water-free adhesive for providing structure to the material having discrete elements during installation, the applicator assembly including: a nozzle having an inlet for receiving the material and an outlet for applying the material to a surface; and an adhesive applicator adjacent to the nozzle for activating the substantially water-free adhesive to provide structure to the material having discrete elements during installation; and a transporter system downstream of the supply of material having discrete elements for delivery of the material to the applicator assembly.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic diagram illustrating an apparatus for installation of a material having discrete elements, such as loose fill insulation constructed according to the present invention;

FIG. 2 is an enlarged view of the applicator assembly of the present invention illustrating the nozzle for applying the material to a surface and the adhesive applicator adjacent to the nozzle for activating the substantially water-free adhesive; and

FIG. 3 is a perspective schematic view of an operator using the present invention to install loose fill insulation into an open wall cavity.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

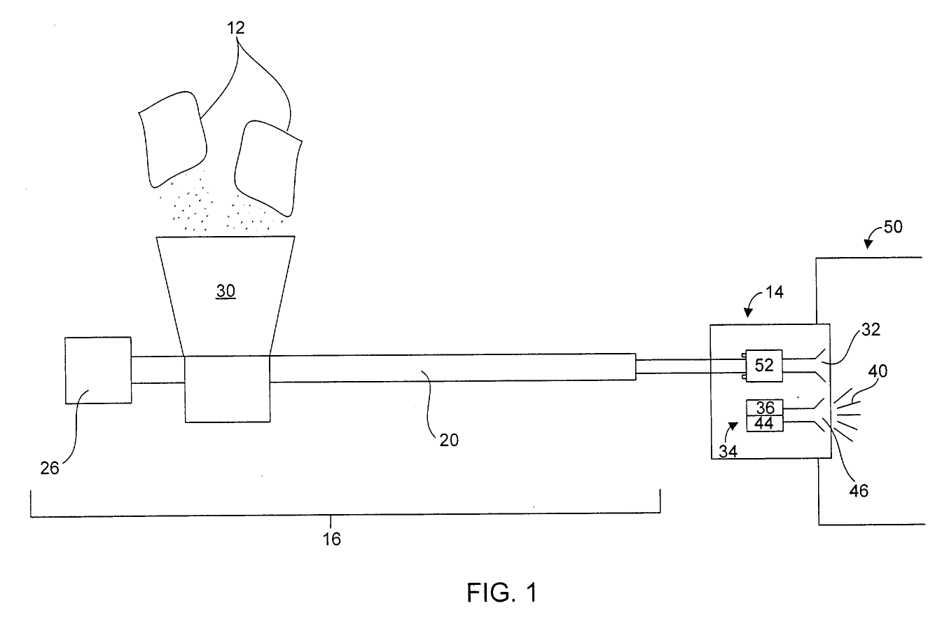

Referring now to the drawings in general and FIG. 1 in particular, it will be understood that the illustrations are for the purpose of describing a preferred embodiment of the invention and are not intended to limit the invention thereto. As best seen in FIG. 1, an apparatus for installation of insulation material, generally designated 10, is shown constructed according to the present invention. The insulation apparatus 10 includes: a supply of insulation material having discrete elements 12; an applicator assembly 14; and a transporter system 16.

The supply of insulation material having discrete elements 12 may be selected from the group consisting of fibrous material, granular material, pellet material and agglomerated material. The insulation material 12 may be inorganic. For example, the inorganic insulation material may be selected from the group consisting of fiberglass, rock wool, pearlite, mineral wool, and asbestos. The supply of material may include organic materials such as cellulose, polystyrene, and polyurethane. The supply of insulation material also may be an organic insulation material such as a natural cellulosic material.

In the preferred embodiment, the supply of insulation material 12 is a non-conductive insulation material. The non-conductive insulation material may be one or more of thermally non-conductive materials, acoustically non-conductive materials and electrically non-conductive materials.

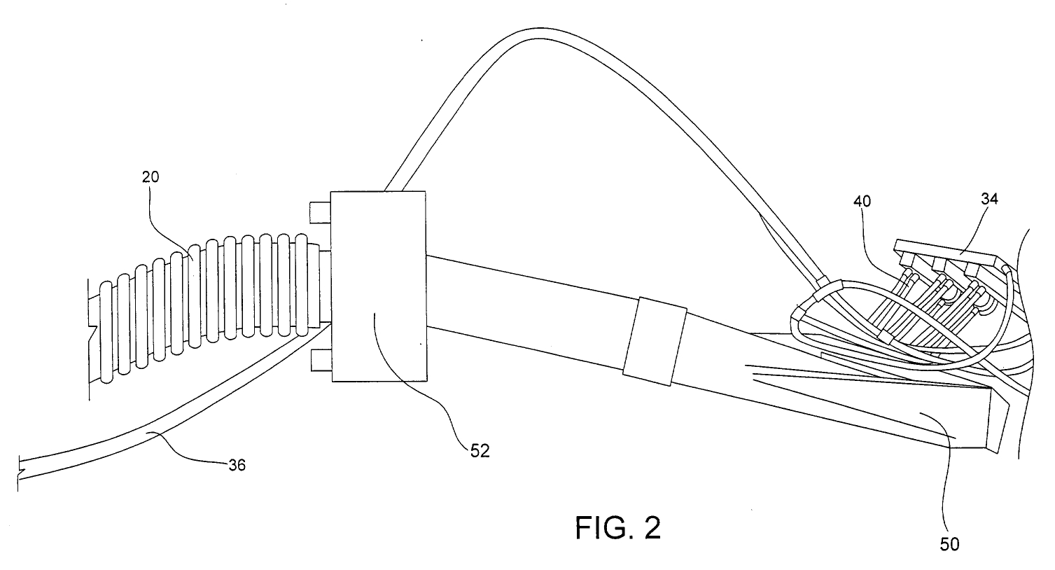

Referring to FIGS. 1 and 2, the transporter system 16 is shown. In the preferred embodiment, the transporter system 16 includes a conduit 20 with an inlet and outlet, an air supply 26, and a debailer 30. The transporter system 16 transports the supply of insulation material 12 to the applicator assembly 14 to start the application process to the walls or ceilings requiring insulation. The bags of insulation material 12 are opened by the debailer 30 and the air supply 26 provides an air stream to blow the insulation material 12 downstream in the conduit 20 to the applicator assembly 14.

The transporter system 16 may also be manually operated since an individual operator may open the bags of insulation material 12 by hand and manually place them within the applicator assembly 14 for application to the desired walls or ceilings.

Again, referring to FIG. 1, the applicator assembly 14 includes a nozzle 32 with an inlet and outlet and an adhesive applicator 34. The applicator assembly 14 further includes an air and solid separator 52 upstream of the nozzle 32. In the preferred embodiment, nozzle 32 containing an inlet and outlet has an outlet, which is wider than it is tall.

The adhesive applicator 34 is comprised of a supply of adhesive 36 and a spray head 40 for supplying adhesive to the insulation material having discrete elements 12 within a distributor 50. The spray head 40 produces a plurality of streams 46 of hot melt adhesive. Distributor 50 is located downstream of the spray head 40 and the nozzle 32. The distributor 50 produces a plurality of air streams mixing the insulation material 12 from the nozzle 32 and the hot melt adhesive 36 from the spray head 40 for final application in said air streams. The air/solids separator 52, which is upstream of the nozzle 32, is a partial separator, which separates greater than about 50% of the air from the insulation material 12.

The supply of adhesive 36 is a hot melt adhesive and, in the preferred embodiment, is a thermoplastic hot melt adhesive. The adhesive applicator 34 further includes a heater assembly 44. The heater assembly 44 may contains a conventional temperature control device (not shown).

In operation, the supply of insulation material having discrete elements 12 is removed from the bags by the debailer 30 of the transporter system 16. The insulation material 12 is fed into the conduit 20 and the air supply 26, which is pumped into the conduit 20, moves the insulation material 12 into the applicator assembly 14. The insulation material 12 travels into the nozzle 32 of the applicator assembly 14. The air and solid stream separator 52 removes the excess air from the insulation material 12 before it reaches the nozzle 32.

The insulation material 12 is forced from the nozzle 32 into the distributor 50. Adhesive from the supply of adhesive 36 is placed within the adhesive applicator 34. The adhesive is heated to the appropriate temperature by the heater assembly 44 to become molten. The melted adhesive is pumped to the distributor 50. The insulation material 12 from the nozzle 32 and the hot melt adhesive from the spray head 40 proceeds to the distributor 50 downstream of the spray head 40 and the nozzle 32. The insulation material and hot melt adhesive are then combined in the distributor 50.

The distributor 50 provides a plurality of streams containing the mixed insulation material and the adhesive for ultimate application on the ceiling or wall. The use of the hot melt adhesive 42 in combination with the insulation material 12 produces a stream, which adheres to the ceiling, or wall to which it is being applied. Attainment of the desired depth of insulation and R-value is possible by manipulating the number of streams that are applied to the subject ceiling or wall. The insulation containing the hot melt adhesive adheres to the ceiling or wall and sets up, thereby providing the desired thickness and R value of insulation called for in the specification of the application job.

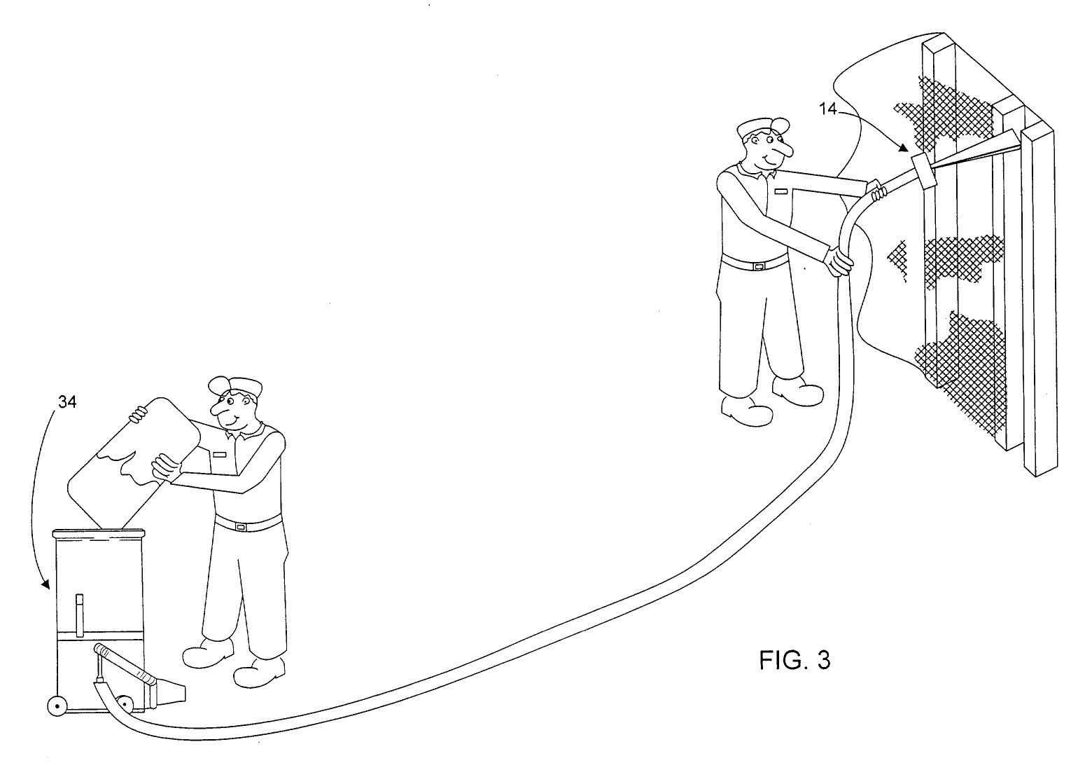

FIG. 3 is a schematic representation of an operator applying the insulation material with hot melt adhesive. The operator, after filling the applicator assembly 34 with insulation material 12 and adhesive 36, may apply the mixed insulation material 12 and adhesive 36 to the wall by manipulating the distributor 50 to the desired insulation level. Because the system is water-free, the present invention of applying insulation with hot melt adhesive eliminates the need for netting or retaining membrane to contain the insulation, or the use of water-based adhesives. This reduces clean up and eliminates mold.

Certain modifications and improvements will occur to those skilled in the art upon a reading of the foregoing description. By way of example, different head configurations could be used to modify air, material and hot melt adhesive flow, as well as the relationship of these flows to each other. Also, the debailer designs may be modified to change the characteristics of the material delivered to the nozzle. In addition, hot melt adhesive could be added to the material prior to debailing and the hot melt entrained within the discrete element matrix activated at the nozzle by thermal or electrical energy at the point of application. It should be understood that all such modifications and improvements have been deleted herein for the sake of conciseness and readability but are properly within the scope of the following claims.

We claim:

1. An apparatus for installation of a material having discrete elements, said apparatus comprising:
(a) a supply of material having discrete elements; and
(b) an applicator assembly for activating a substantially water-free adhesive for providing structure to said material having discrete elements during installation.

2. The apparatus according to claim 1, further including a transporter system downstream of said supply of material having discrete elements for delivery of said material to said applicator assembly.

3. The apparatus according to claim 2, wherein, said transporter system includes a conduit with an inlet and outlet; and an air supply to move said material having discrete elements through said conduit.

4. The apparatus according to claim 3, wherein said transporter system further includes a debailer for debailing bundles of said material having discrete elements.

5. The apparatus according to claim 1, wherein said supply of material having discrete elements is selected from the group consisting of fibrous material, granular material, pellet material and agglomerated material.

6. The apparatus according to claim 5, wherein the supply of material having discrete elements is inorganic.

7. The apparatus according to claim 6, wherein said inorganic material is selected from the group consisting of fiberglass, rock wool, pearlite, mineral wool, and asbestos.

8. The apparatus according to claim 5, wherein said supply of material having discrete elements is organic.

9. The apparatus according to claim 8, wherein said organic material is a natural material.

10. The apparatus according to claim 9, wherein said natural material is cellulosic.

11. The apparatus according to claim 1, wherein said supply of material having discrete elements is a non-conductive material.

12. The apparatus according to claim 11, wherein said supply of non-conductive material is a thermally non-conductive material.

13. The apparatus according to claim 11, wherein said supply of non-conductive material is an acoustically non-conductive material.

14. The apparatus according to claim 11, wherein said supply of non-conductive material is an electrically non-conductive material.

15. An applicator assembly for an apparatus for installation of a supply of material having discrete elements, said apparatus comprising:
(a) a nozzle having an inlet for receiving said material and an outlet for applying said material to a surface; and
(b) an adhesive applicator adjacent to said nozzle for activating a substantially water-free adhesive to provide structure to said material having discrete elements during installation.

16. The apparatus according to claim 15, wherein the width of the outlet of said nozzle is greater than its height.

17. The apparatus according to claim 15, wherein the adhesive applicator includes a supply of adhesive material and a spray head for supplying adhesive to said material having discrete elements.

18. The apparatus according to claim 17, wherein said supply of adhesive includes a hot melt adhesive and a heater assembly.

19. The apparatus according to claim 18, wherein said hot melt adhesive is a thermoplastic adhesive.

20. The apparatus according to claim 18, wherein said heater assembly further includes a temperature control device.

21. The apparatus according to claim 17, wherein said spray head for supplying adhesive to said material having discrete elements provides a plurality of streams.

22. The apparatus according to claim 21, further including a distributor downstream of said spray head.

23. The apparatus according to claim 22, wherein said distributor downstream of said spray head provides a plurality of air streams.

24. The apparatus according to claim 15, wherein said applicator assembly further includes an air/solids separator upstream of said nozzle.

25. The apparatus according to claim 24, wherein said air/solids separator upstream of said nozzle is a partial separator.

26. The apparatus according to claim 25, wherein said partial separator removes greater than about 50% of the air from the air/solids mixture.

27. An apparatus for installation of a material having discrete elements, said apparatus comprising:
(a) a supply of material having discrete elements;
(b) an applicator assembly for activating a substantially water-free adhesive for providing structure to said material having discrete elements during installation, said applicator assembly including: (i) a nozzle having an inlet for receiving said material and an outlet for applying said material to a surface; and (ii) an adhesive applicator adjacent to said nozzle for activating the substantially water-free adhesive to provide structure to said material having discrete elements during installation; and
(c) a transporter system downstream of said supply of material having discrete elements for delivery of said material to said applicator assembly.

28. The apparatus according to claim 27, wherein, said transporter system includes a conduit with an inlet and outlet; and an air supply to move said material having discrete elements through said conduit.

29. The apparatus according to claim 28, wherein said transporter system further includes a debailer for debailing bundles of said material having discrete elements.

30. The apparatus according to claim 27, wherein said supply of material having discrete elements is selected from the group consisting of fibrous material, granular material, pellet material and agglomerated material.

31. The apparatus according to claim 30, wherein the supply of material having discrete elements is inorganic.

32. The apparatus according to claim 31, wherein said inorganic material is selected from the group consisting of fiberglass, rock wool, pearlite, mineral wool, and asbestos.

33. The apparatus according to claim 30, wherein said supply of material having discrete elements is organic.

34. The apparatus according to claim 33, wherein said organic material is a natural material.

35. The apparatus according to claim 34, wherein said natural material is cellulosic.

36. The apparatus according to claim 27, wherein said supply of material having discrete elements is a non-conductive material.

37. The apparatus according to claim 36, wherein said supply of non-conductive material is a thermally non-conductive material.

38. The apparatus according to claim 36, wherein said supply of non-conductive material is an acoustically non-conductive material.

39. The apparatus according to claim 36, wherein said supply of non-conductive material is an electrically non-conductive material.

40. The apparatus according to claim 27, wherein the width of the outlet of said nozzle is greater than its height.

41. The apparatus according to claim 27, wherein the adhesive applicator includes a supply of adhesive material and a spray head for supplying adhesive to said material having discrete elements.

42. The apparatus according to claim 41, wherein said supply of adhesive includes a hot melt adhesive and a heater assembly.

43. The apparatus according to claim 42, wherein said hot melt adhesive is a thermoplastic adhesive.

44. The apparatus according to claim 42, wherein said heater assembly further includes a temperature control device.

45. The apparatus according to claim 41, wherein said spray head for supplying adhesive to said material having discrete elements provides a plurality of streams.

46. The apparatus according to claim 45, further including a distributor downstream of said spray head.

47. The apparatus according to claim 46, wherein said distributor downstream of said spray head provides a plurality of air streams.

48. The apparatus according to claim 27, wherein said applicator assembly further includes an air/solids separator upstream of said nozzle.

49. The apparatus according to claim 48, wherein said air/solids separator upstream of said nozzle is a partial separator.

50. The apparatus according to claim 49, wherein said partial separator removes greater than about 50% of the air from the air/solids mixture.

51. A method for installation of a loose fill insulation material having discrete elements, said method comprising the steps of:
(a) providing a supply of loose fill installation material having discrete elements; and
(b) activating a substantially water-free adhesive for providing structure to said material having discrete elements during installation.

52. A method for installation of a loose fill insulation material having discrete elements, said method comprising the steps of:
(a) receiving said material into an inlet of a nozzle and applying said material to a surface from the outlet of said nozzle; and
(b) activating a substantially water-free adhesive to provide structure to said material having discrete elements during installation.

53. A method for installation of a loose fill insulation material having discrete elements, said method comprising the steps of:
(a) providing a supply of loose fill installation material having discrete elements;
(b) transporting said supply of material having discrete elements to an applicator assembly; and
(c) activating a substantially water-free adhesive for providing structure to said material having discrete elements during installation, said applicator assembly including: (i) a nozzle having an inlet for receiving said material and an outlet for applying said material to a surface; and (ii) an adhesive applicator adjacent to said nozzle for activating the substantially water-free adhesive to provide structure to said material having discrete elements during installation.

54. An insulation material formed from loose fill insulation, said insulation material comprising:
(a) a supply of material having discrete elements; and
(b) a substantially water-free adhesive for providing structure to said material having discrete elements.

55. The insulation material according to claim 54, wherein said supply of material having discrete elements is selected from the group consisting of fibrous material, granular material, pellet material and agglomerated material.

56. The insulation material according to claim 55, wherein the supply of material having discrete elements is inorganic.

57. The insulation material according to claim 56, wherein said inorganic material is selected from the group consisting of fiberglass, rock wool, pearlite, mineral wool, and asbestos.

58. The insulation material according to claim 55, wherein said supply of material having discrete elements is organic.

59. The insulation material according to claim 58, wherein said organic material is a natural material.

60. The insulation material according to claim 59, wherein said natural material is cellulosic.

61. The insulation material according to claim 54, wherein said supply of material having discrete elements is a non-conductive material.

62. The insulation material according to claim 61, wherein said supply of non-conductive material is a thermally non-conductive material.

63. The insulation material according to claim 61, wherein said supply of non-conductive material is an acoustically non-conductive material.

64. The insulation material according to claim 61, wherein said supply of non-conductive material is an electrically non-conductive material.

65. The insulation material according to claim 54, wherein said substantially water-free adhesive for providing structure to said material having discrete elements includes a hot melt adhesive.

66. The insulation material according to claim 65, wherein said hot melt adhesive is a thermoplastic adhesive.

67. The insulation material according to claim 65, wherein said hot meat adhesive is distributed in a plurality of streams.
